(19) United States
(12) Patent Application Publication
(10) Pub. No.: US 2026/0054359 A1
(43) Pub. Date: Feb. 26, 2026

(54) SETTING DEVICE

(71) Applicant: SFS Group International AG, Heerbrugg (CH)

(72) Inventor: Yves PÖLTINGER, St. Margrethen (CH)

(73) Assignee: SFS Group International AG, Heerbrugg (CH)

(21) Appl. No.: 19/304,783

(22) Filed: Aug. 20, 2025

(30) Foreign Application Priority Data
Aug. 20, 2024 (EP) 24195390.0

(51) Int. Cl. B25B 21/00; E04D 15/04

(52) U.S. Cl. CPC B25B 21/007; E04D 15/04; E04D 2015/047

(57) ABSTRACT

A setting device (100) for mounting roof membranes (470) and insulation layers (450) on a substructure (460) uses an arrangement having a fastener (210) and a ferromagnetic load distribution washer (200) for fastening. The setting device includes a movable frame (130) having a first feed device (110) for load distribution washers and a second feed device (120) for fasteners. The setting process starts with manual actuation of a vertically arranged pressure rod (145) that can be telescoped against a spring. A drive unit (150) attached thereto with a motor-driven drive mandrel (155) drives a fastener from a mounting guide (320) through a load distribution washer held in a mounting guide in the base assembly (310) of the setting device. A magnet system, designed so that the load distribution washer to be set is fixable in a suspended manner in the mounting bracket (300) without an additional mechanical retainer, is used.

### CROSS-REFERENCE TO RELATED APPLICATIONS

This application claims priority from European Patent Application No. 24195390.0, filed Aug. 20, 2024, which is incorporated herein by reference as if fully set forth.

### TECHNICAL FIELD

The present invention relates to a setting device for screwing flat roof systems such as roof membranes (sheets), metal sheets, plasterboard panels, and insulation layers onto flat roofs.

### BACKGROUND

In the construction of flat roofs, especially on industrial buildings, it is common practice to apply one or more layers of insulating material for insulation to a structurally load-bearing roof surface made of wood, sheet steel, or concrete. To protect these layers from the effects of weather, plastic roofing foils (roofing sheets or roofing membranes) are commonly used. These are rolled out over the entire surface and bonded or welded together at the overlapping areas (seams). Both the insulation layers and the foil must be secured to the substructure. One of the well-known methods for substructures made of wood or sheet metal is to fasten the roof membranes or insulation layers with appropriately long self-drilling screws. The screws are fitted with round or square load distribution washers, similar to oversized washers, which distribute the tensile stress of the screw over the roof membranes or insulation layers. The sealing foils are then often bonded and welded to the distribution washers.

Setting such fasteners is a time-consuming process, as several thousand such fastening points may have to be installed in a controlled manner on large roof areas.

Apart from this main application, this type of fastening with screws and load distribution washers is also used for other materials where the tensile stress of the screw must be distributed over a large area.

### DESCRIPTION OF THE PRIOR ART

Setting devices that facilitate the setting of a combination of load distribution washers and self-drilling screws have long been known in the prior art, in particular allowing the operator to work while standing.

A fundamental problem with this type of setting device is that the load distribution washer and fastener (screw) should only be brought together in the final stage immediately before the setting process. To do this, a washer is usually taken from a supply of load distribution washers using a sliding carriage and brought into a mounting position.

The screw is fed separately by hand through a drop tube into a centering or guide sleeve, which serves as a mounting guide. Alternatively, a magazine strip can be provided from which one screw is separated per setting operation, synchronized with the downward movement of the pressure rod.

The guide sleeve of the mounting guide is always aligned and equipped in such a way that it positions and holds the drill tip of the screw from above in front of the opening of the load distribution washer. The bit of the drive unit, which engages with the screw from above, then guides and drives the screw. By pressing down the handles, the drive unit guides the screw vertically through the load distribution washer into the insulating layers and then drills it into the load-bearing substructure. Ideally, the load distribution washer is only released from its mounting position and pressed onto the insulating layer when the lowering screw head makes this necessary.

Such a device is shown in EP 0 621 108 A1. The load distribution washer is held in the mounting position by a pawl, whose lock is released mechanically.

EP 0 003 004 A1 provides pivot pins or flaps that offer a spring-loaded retaining position for the washers, which can be moved into a release position in good time during the setting process by means of control rods.

The load distribution washer holder must therefore fulfill two conflicting tasks during the setting process: on the one hand, it must ensure a fixed and precise position, and on the other hand, it must release the washer in good time without hindering the setting process before or after. A suitable solution should not be too complex mechanically, should be reliable both in terms of holding and release, and should be suitable for use under construction site conditions.

### SUMMARY

The present invention has the object of replacing these mechanical holding devices with a simplified holding system.

This object is solved by a magnetic holder that holds the load distribution washers in the mounting position.

A setting device designed to solve this object can fasten an arrangement consisting of a fastener and a ferromagnetic load distribution washer through insulating layers onto a substructure. For this purpose, the basic arrangement comprises a movable frame with a first feed device for load distribution washers and a second feed device for fasteners. Such setting devices are moved on large, flat roof surfaces, which is why combinations of a single wheel axle and supports have proven effective in keeping the setting device securely in place during operation.

The setting process is known from the prior art as being carried out by means of a manual actuating element with a vertically arranged pressure rod that can be telescoped against a spring. A drive unit with a motor-driven drive mandrel is attached to the actuating element, which can drive a fastener during the setting process. The drive unit is usually a type of drill, often battery-powered to avoid the need for a power cable. The drive mandrel usually has a force application point at its open end in the form of a blade that can engage in the head of the fastener. The longitudinal axis of the drive mandrel defines a working axis; this is usually perpendicular to the base (roof surface) when the setting device is in the working position.

As mentioned above, the arrangement of load distribution washer and fastener is usually used to fix insulation layers on industrial roofs. Due to the large number of identical fastening operations with high setting quality requirements, a lean work process is important. For this purpose, the setting device presented here has a mounting bracket for a load distribution washer and a mounting guide for a fastener, both of which are referred to as a readiness position in the setting device for the setting operation. A load distribution washer suitable for setting usually has a substantially flat, disc-shaped contour extending in a main plane and a centrally symmetrical through-opening. The term “disc-shaped in a main plane” does not exclusively refer to a purely flat, level design. The main plane refers to the plane in which a load distribution washer extends over most of its surface. Load distribution washers of the type described have a rotationally symmetrical basic shape, which is suitable for use with the setting device described here.

Load distribution washers for the purpose described here may have beads for stiffening, point-shaped nubs or claws to improve the hold of a load distribution washer on the insulation layers. For practical reasons, the load distribution washers are often designed so that they can be easily stacked. They are often made of galvanized sheet steel by punching and embossing. If punching waste is to be avoided, square or polygonal basic shapes are more suitable.

The first feed device (for load distribution washers) is designed so that each load distribution washer can be conveyed individually from a magazine (washer supply) or from a single feed into the mounting bracket. The second feed device (for fasteners) can be equipped with a feed chute for individually inserted fasteners or with a separating device for fasteners from a magazine strip. This feed device conveys the fasteners individually into the mounting guide. The mounting guide in turn ensures that the individual or separated fasteners are aligned and positioned along the working axis.

The mounting bracket is designed to position a load distribution washer in the mounting position on a mounting surface so that the working axis is aligned with the through-opening of the load distribution washer. The load distribution washer and fasteners are therefore aligned with each other. The main plane of the load distribution washer (in the mounting position) is coplanar to the mounting surface or coincides with it. The contact surface does not necessarily have to be flat in order to provide the top of the load distribution washer with the largest possible contact area in the mounting bracket. For example, it can also be a ring-shaped contact surface that is symmetrically positioned around the working axis. Point contacts are also possible, depending on the type, dimensions, and weight of the load distribution washer.

It has been shown that, depending on the design of the mounting bracket and the type of load distribution washers, mechanical longitudinal and lateral stops in the mounting bracket can be dispensed with, which in some cases can facilitate handling because jamming or tilting can be largely avoided.

This is achieved in particular by arranging a magnet system in the mounting bracket, the strength of which is designed so that a load distribution washer to be set can be fixed in the mounting bracket without additional mechanical retaining means. The magnet system is designed so that the load distribution washer is held securely in the mounting position but is released in good time during the setting process. “Without additional mechanical retaining means” is to be understood here as meaning that without the magnet system, a load distribution washer would fall out of the mounting bracket.

The magnetic field can be generated statically by an arrangement of permanent magnets, but also by one (or more) magnetic coils. Magnets, especially permanent magnets, are commercially available in a wide variety of sizes, shapes, and field strengths. Those skilled in the art can find out how the above-mentioned holding or release conditions can be met by simply trying them out. In doing so, they will take into account the weight of the load distribution washer as well as the possibilities for arranging the magnets within the mounting bracket. A modular design may allow the mounting bracket in the setting device to be interchangeable, which would also enable the use of specially tailored magnet systems depending on the type of load distribution washer.

The magnet system can thus consist of a ring-shaped permanent magnet, a ring coil or a plurality of bar magnets arranged symmetrically around the working axis in the mounting bracket. A symmetrical arrangement around the end area of the mounting guide for the fastener, in a plane close to or parallel to the contact surface, is particularly preferred. A magnetic field that is rotationally symmetrical around the working axis will have practically no effect on a fastener that may also be ferromagnetic, because it is located on the working axis where the magnetic field does not exert any resulting force on it.

As will be explained later, the symmetrical magnetic field supports centering of the load distribution washer in the mounting position. In addition, mechanical centering elements can also be provided, such as contour elements in the mounting bracket, which form a positive connection with correspondingly contoured areas of the load distribution washer. Furthermore, a mechanical stop (end stop) can be provided in the mounting bracket to limit the movement of a load distribution washer along the displacement path in the mounting bracket.

The mounting bracket forms part of the base assembly of the setting device, which also includes the chassis and other components. It is explained in more detail with reference to FIG. 2. The magnets can be inserted into appropriately designed cut-outs in the base assembly. A common material for such setting devices is aluminum, in which appropriate openings can be made. Another option would be to arrange a magnet system that can be replaced in or on the base assembly, thus providing, for example, magnets of different strengths for load distribution washers of different weights.

For those skilled in the art, the best way to determine the magnet shapes, magnet strengths, pole alignment, and their arrangement is by trial and error with a suitable setting device. Permanent bar magnets or ring magnets have been used successfully in the setting device shown here. This allows arrangements of two or three bar magnets to be realized. With two bar magnets of equal field strength in a symmetrical arrangement around the mounting guide for the fastener, it was found that the alignment of the poles does not affect the function of the fastener. If three bar magnets are arranged along the sides of an equilateral triangle, it is recommended to align the south pole of one magnet with the north pole of the next magnet.

Short bar magnets, for example in cylindrical form, can also be used, with their magnetic fields preferably arranged parallel to the working axis. The polarity of the individual magnets must be aligned so that the conditions for symmetry of the magnetic field are met, which can be determined by trial and error.

Permanent magnets are manufactured on an industrial scale by pressing a neodymium-iron-boron alloy in powder form into shape and then magnetizing it according to the intended use. This allows for a wide variety of shapes and polarization directions to be achieved.

In addition to the symmetrical design of the magnetic field around the working axis, it has been shown that a complementary asymmetry component can be useful. This generates a static magnetic field component in the mounting bracket, which exerts a resulting force on a distribution washer in the mounting position. The asymmetry is chosen so that a vector component of this force effect points away from the mounting position in the extension of the displacement path. The reason for this design is that when a load distribution washer is inserted into the mounting bracket, a magnetic field component always “pulls” the load distribution washer in the transport direction. The symmetrical magnet system also has this basic effect until the load distribution washer is centered. However, depending on the type, size, and weight of the load distribution washer, an additional, non-disappearing component may be advantageous.

The asymmetry can basically be achieved in two ways: A magnet system as described above can be given a resulting asymmetry by means of an additional or supplementary magnet. Alternatively or equivalently, the asymmetry component can also be achieved by a fundamentally asymmetrical arrangement of the magnets forming the magnet system.

A method for setting a load distribution washer by means of a fastener using a setting device as described here comprises the following steps. A person skilled in the art will recognize that certain steps (movement sequences) which must necessarily be described here in a logical sequence may also be performed simultaneously or overlap in time. The method steps are as follows:
Providing a setting device with a supply of load distribution washers in a magazine and providing at least one fastener via a second feed device.
Positioning the setting device at a target position.

The actual setting process begins when the actuating element on the handles is pressed down, wherein the vertical movement of a pressure rod is translated into:
On the one hand, a horizontal movement of a feed blade in a displacement path and
on the other hand, a lowering movement of the drive mandrel driven by the drive unit along the working axis and
centering of a fastener in a mounting guide on the working axis
wherein the horizontal movement of the feed blade moves a single load distribution washer from the magazine in a channel on a horizontal displacement path into a mounting bracket.

Here, the load distribution washer is released from a mechanical guide into the installation space of the mounting bracket, where the magnetic field of the magnet system pulls the load distribution washer into the mounting position and temporarily fixes it there. The design of the magnet system as symmetrical or asymmetrical is irrelevant for this basic movement sequence.

The load distribution washer then rests against a contact surface, attracted by the magnet system. This magnetic field allows the load distribution washer to be held centered around the working axis without any additional mechanical clamps or holders, with the working axis and the through-opening of the load distribution washer aligned.

As the setting process continues, the fastener guided and driven by the drive mandrel can pass through the through-opening. As the lowering movement continues, the head of the fastener then strikes the through-opening and releases the load distribution washer from the contact surface against the magnetic force. The setting process is complete when the fastener is anchored in the substructure and the load distribution washer is inserted into the working surface as specified and secures, for example, an insulation layer.

In a further step, the setting device is returned to its starting and initial position by moving the actuating element vertically back, and is then ready for the next setting process. The return movement can be supported by spring force.

The setting process described above can alternatively be carried out in such a way that the mounting bracket is not loaded with a load distribution washer before the setting process by pressing down the actuating element, but after the setting process by moving it back vertically. This sequence of movements has the advantage that the spring-assisted return movement supports the loading process of the mounting bracket, so that a load distribution washer is already centered in the mounting bracket during the actual setting process.

In the first variant of the method, the preparation process for the fastener and the load distribution washer is thus part of the setting process and can be carried out in one step.

The disadvantage of the second variant is that a load distribution washer must be conveyed into the mounting bracket before the first actual setting process, which is usually done by means of an “empty” setting process without a fastener inserted. In addition, after the last setting operation, a load distribution washer may remain in the mounting bracket and must then be removed manually. Nevertheless, both variants can be useful in appropriate application scenarios.

### BRIEF DESCRIPTION OF THE DRAWINGS

FIG. 1 shows a side view of a setting device as described here.

FIG. 2 shows details of a mounting bracket for such a setting device.

FIG. 3A shows a loaded mounting bracket with a symmetrical magnet system.

FIG. 3B shows a loaded mounting bracket with an asymmetrical magnet system.

FIG. 4 shows a load distribution washer in section.

FIG. 5 shows a selection of possible arrangements of magnets as a magnet system in a mounting bracket of a setting device according to the present description.

FIG. 6 shows an example of the roof structure of an industrial roof with a trapezoidal sheet metal substructure and an insulating layer on top.

FIG. 7 shows an example of the relative position of the load distribution washer and fastener to each other before the insertion process.

FIGS. 8A to 8C show magnet systems supplemented by an asymmetry component.

### DETAILED DESCRIPTION

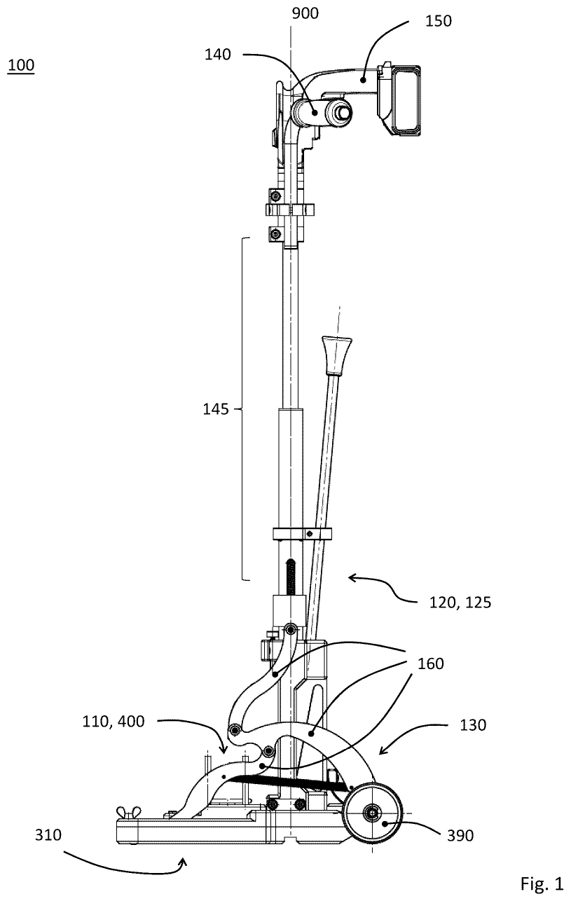

FIG. 1 provides an overview of the structure of a setting device of the type described here. The description is given from bottom to top with reference to a standing device.

The setting device 100 shown comprises a base assembly 310 which accommodates the mounting bracket 300 (not visible) and the magazine 400. The magazine 400 represents the visible part of the first feed device 110 for load distribution washers. At the rear end of the base assembly 310, facing the operator's position, is the wheel axle 390. The base assembly 310 and wheel axle 390 together form a movable frame 130. The setting process itself is essentially effected by manually pressing down the actuating element 140, symbolized here in the figure by two handles (one shown). The downward movement causes the pressure rod 145 to move downwards along the working axis 900, and this downward movement is transmitted via the lever unit 160 to both the first and second feed devices 110, 120. The second feed device is recognizable by the feed shaft 125 for individual fasteners. An actuator unit 150 is shown in the area of the handles, which acts on the drive mandrel 155 (not visible).

FIG. 2 highlights the essential components of the mounting bracket 300 for load distribution washers 200, the magazine 400, and the mounting guide 320 for fasteners 210, which are arranged together in the base assembly 310 or form part of it. In FIG. 2, the magazine 400 is arranged on the right and holds a supply 410 of stacked load distribution washers. A load distribution washer 200 that is to be transferred from the magazine 410 into the mounting bracket 300 must be moved horizontally along a displacement path 350 in a channel 355 until the load distribution washer 200 is aligned with the contact surface 330 and is held there by the magnet system 500. This horizontal displacement is effected by means of a feed blade 340, which is actuated by the lever unit 160. The direction of movement of the blade 340 is shown by an arrow. In the mounting bracket 300, the load distribution washer 200 is held magnetically on the contact surface 330. It is shown here centered around the axis 900, along which a fastener 210 and the drive mandrel 155 shown in engagement with the fastener are also shown. FIG. 2 clearly shows that the downward movement of the drive mandrel 155 will guide the fastener 210 through the central opening 220 in the load distribution washer. The head of the fastener 210 will then strike the collar of the central opening 220 or the recess 240, which will immediately cause the load distribution washer to detach from the magnetic holder in the mounting bracket 300.

The lower half of FIG. 2 shows the situation in a top view. The displacement path can be implemented as a channel with only narrow side guides or lateral supports 360. The feed blade 340 is only shown schematically. An advantageous feature of the magnetic holder is that there are no mechanical elements in the mounting bracket 300 that can prevent the load distribution washer 200 from being released during the setting process. The risk of jamming is therefore significantly reduced.

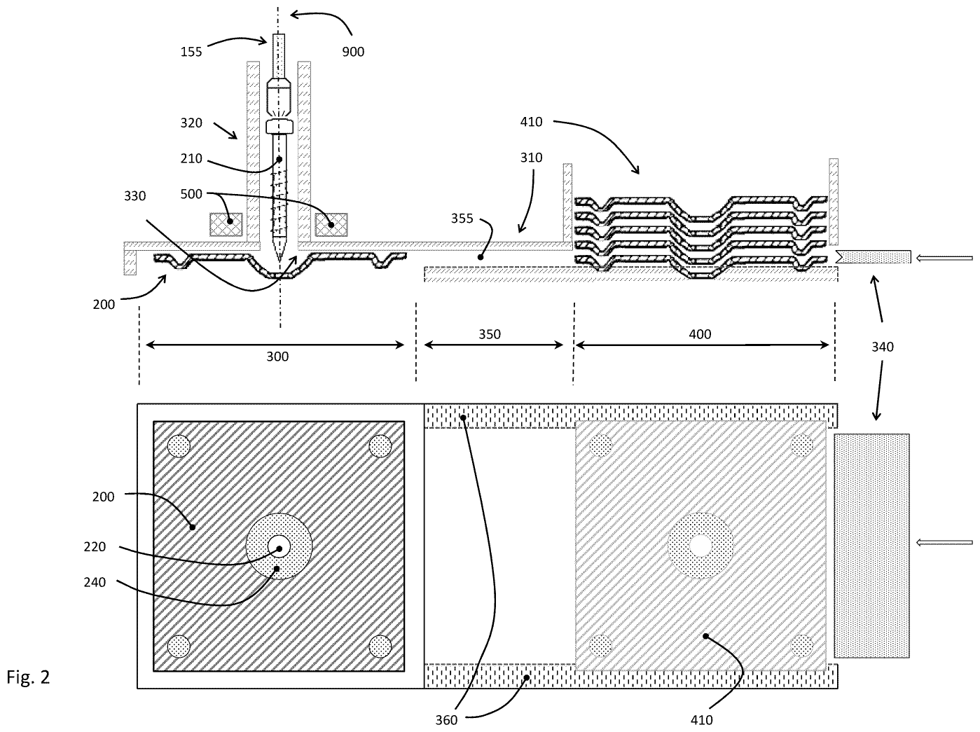

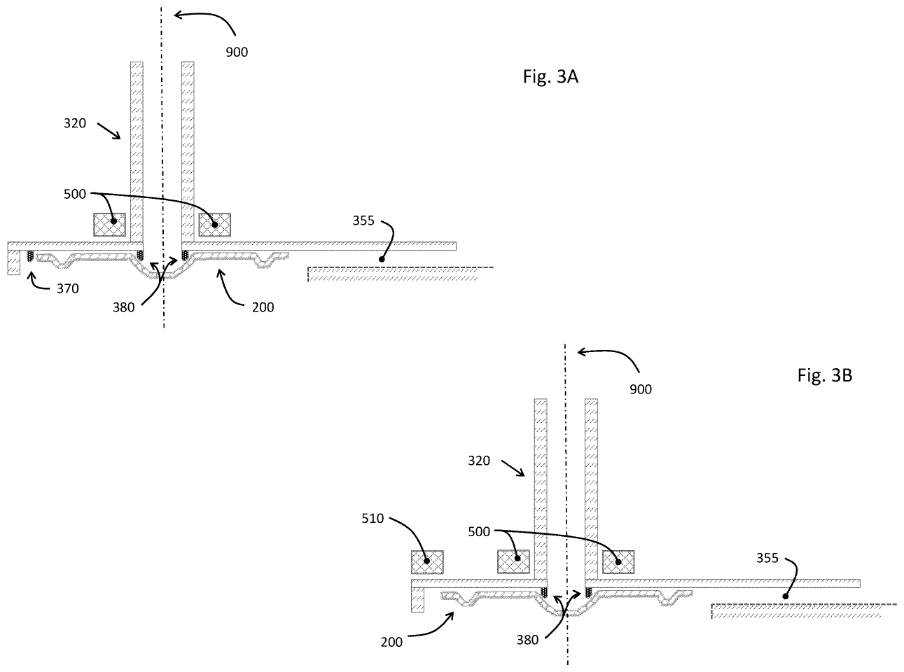

FIGS. 3A and 3B are excerpts from FIG. 2 with minor changes in the area of the mounting bracket 300. Parts that have already been explained in connection with FIG. 2 are therefore not listed again here.

In FIG. 3A, the fastener and the drive mandrel have been omitted. These are optional centering and stop means (370, 380) that can be installed in the mounting bracket to ensure the placement or centering of a load distribution washer 200. As can be seen, centering means 380, which engage in the recess 240 in a form-fitting or point-contact manner, support the correct positioning of the load distribution washer without hindering the subsequent engagement of a fastener. Similarly, a stop means 370 serving as a longitudinal stop can be helpful. Those skilled in the art will use such means depending on the situation and technical requirements. It is important here that the stop and centering devices (370, 380) do not constitute mechanical retaining devices or support the retaining process.

FIG. 38 shows the centering means known from FIG. 3A and explained there. Newly shown, by way of example, is the asymmetry component that can supplement the symmetrical magnet system 500. Here, a supplementary magnet is installed in such a way that it can specifically support the translational movement from the magazine 400 into the mounting bracket 300 in the final phase.

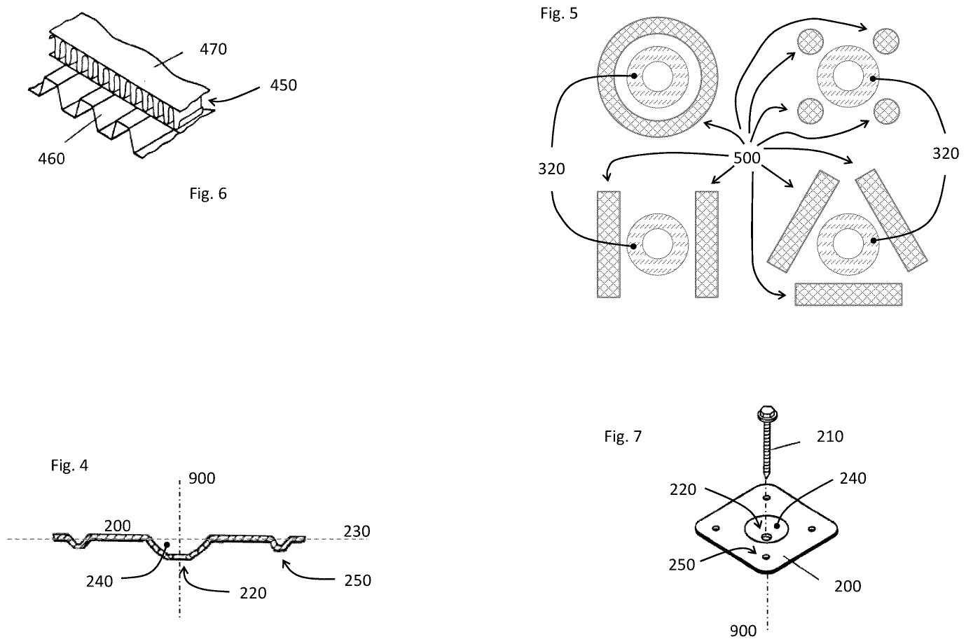

FIG. 4 shows a load distribution washer 200 in a diagonal section with its central through-opening 220 and its main plane 230. FIG. 7 shows the same disc in an oblique top view together with a spaced fastener 210 arranged along the working axis 900. The working axis 900 running through the through-opening 220 of the load distribution washer 200 is shown in both figures. The (retaining) cams 250 support the retaining effect of the load distribution washer 200 after its assembly and also form a twist protection. FIG. 7 clearly shows that, after installation, the head of the fastener 210 can lie in a recess 240 in the load distribution washer 200 and thus does not protrude above the surface of the load distribution washer 200.

FIG. 6 shows an application for the setting device described here, namely the fastening of a roof membrane 470 via an insulation layer 450 on a substructure (trapezoidal sheet metal) 460. There are also insulation materials that can engage positively in the trapezoidal shape.

FIG. 5 shows various arrangements of magnets that together form a (symmetrical) magnet system 500 as described here. The illustration corresponds to a view along the working axis (perpendicular to the drawing plane, not shown). Clockwise starting from top left: (1) A single ring-shaped magnet, arranged symmetrically around the working axis. (2) Individual cylindrical magnets arranged in a circle around the working axis. The polarity is preferably also distributed symmetrically. (3) Bar magnets arranged in an equilateral triangle. Due to the odd number of magnets, an arrangement in which one south pole of each magnet faces the north pole of the next magnet is recommended. (4) When arranging 2 bar magnets, it has been found that the pole orientation is irrelevant for the function.

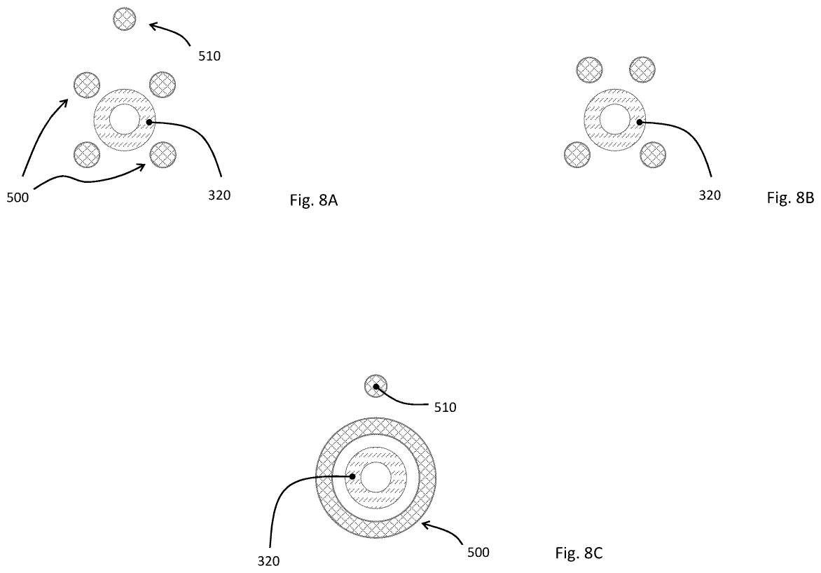

FIGS. 8A and 8C show arrangements of symmetrical magnet systems 500 around a mounting guide 320 plus a single, supplementary asymmetrical component 510. Equivalently, the arrangement in FIG. 8A can be developed into an asymmetrical configuration, see FIG. 8B.

1. A setting device (100) for setting an arrangement including a fastener (210) and a ferromagnetic load distribution washer (200) used to mount root membranes (470) and insulation layers (450) on a substructure (460), the setting device (100) comprising:
a movable frame (130) including:
a first feed device (110) for load distribution washers;
a second feed device (120) for fasteners;
a manual actuating element (140) for a setting process with a vertically arranged pressure rod (145) that is adapted to be telescoped against a spring;
a drive unit (150) attached to the manual actuating element with a motor-driven drive mandrel (155) for driving a fastener during the setting operation, wherein a longitudinal axis of this drive mandrel (155) defines a working axis (900);
a mounting bracket (300) for a load distribution washer in the mounting position;
a mounting guide (320) for a fastener in the mounting position; wherein
the load distribution washer (200) suitable for setting has a substantially flat, disc-shaped contour extending in a main plane and a centrally symmetrical through-opening (220);
the first feed device (110) is configured such that the load distribution washer (200) is conveyable individually from a magazine (400) or from an individual feed into the mounting bracket (300) along a displacement path (350);
the second feed device (120) is adapted to convey the fastener (210) individually from a feed shaft (125) or a magazine strip into the mounting guide (320);
the mounting guide (320) is adapted to align and position the fastener along the working axis (900);
wherein, in the mounting position, the load distribution washer (200) is arranged in the mounting bracket (300) at a contact surface (330) of the mounting bracket (300) such that the working axis (900) points through the through-opening (220) of the load distribution washer (200); and
a magnet system (500) arranged in the mounting bracket (300), the magnet system (500) generates a magnetic field in the mounting bracket (300), a strength of the magnetic field being designed such that a load distribution washer (200) to be set is adapted to be fixed in a suspended position in the mounting bracket (300) without an additional mechanical holder.

2. The setting device according to claim 1, wherein the magnet system (500) is arranged in a plane parallel to the contact surface (330) at a distance therefrom.

3. The setting device according to claim 1, wherein the magnet system (500) comprises one or more magnets which are arranged around the working axis (900) in the mounting bracket (300) such that the magnetic field that is formed is rotationally symmetrical about the working axis (900).

4. The setting device according to claim 3, wherein the one or more magnets include at least one of:
a) a ring-shaped permanent magnet,
b) a ring coil,
c) two bar magnets arranged in parallel,
d) three bar magnets arranged along sides of an equilateral triangle, or
e) a plurality of short bar magnets whose magnetic fields are aligned parallel to the working axis (900).

5. The setting device according to claim 1, wherein the magnet system (500) comprises an asymmetry component (510) which generates a static magnetic field component in the mounting bracket (300) which exerts a resulting force effect on a distribution washer (200) in the mounting position, and a vector component (520) of the resulting force acts away from the mounting position in an extension of the displacement path (350).

6. The setting device according to claim 5, wherein the asymmetry component (510) is caused by a supplemental magnet.

7. The setting device according to claim 5, wherein the asymmetry component (510) is caused by an asymmetrical arrangement of the magnets forming the magnet system (500).

8. The setting device according to claim 1, further comprising a mechanical centering element (380) in the mounting bracket (300), which centers the load distribution washer (200) in the mounting position symmetrically to the working axis (900).

9. The setting device according to claim 1, further comprising a mechanical stop (370) in the mounting bracket (300), that is adapted to limit a movement of the load distribution washer (200) along the displacement path (350) in the mounting bracket (300).

10. A method for setting a load distribution washer (200) with a fastener (210) using a setting device according to claim 1, the method comprising the following steps:
providing the setting device (100) with a load distribution washer supply (410) in the magazine (400);
providing one of the fasteners (210) via the second feed device (120);
positioning the setting device (100) at a target position;
pressing down the actuating element (140), wherein a vertical movement of a pressure rod (145) is translated into a horizontal movement of a feed blade (340) and into a lowering movement of the drive mandrel (155) driven in rotation by the drive unit (150) along the working axis (900);
centering the fastener (210) in the mounting guide (320) on the working axis (900)
the horizontal movement of the feed blade (340) causing a single said load distribution washer (200) to be moved from the magazine (400) in a channel (355) on a horizontal displacement path (350) into the mounting bracket (300);
holding the single said load distribution washer on the contact surface (330) by the magnet system (500), without any further mechanical retainer, about the working axis (900) such that the working axis (900) and the through-opening (220) of the load distribution washer (200) are aligned;
passing the fastener (210) guided and driven by the drive mandrel (155) through the through-opening (220);
due to a resulting lowering movement, the fastener (210) engaging with the through-opening (220);
lifting the load distribution washer (200) off the contact surface (330) against the magnetic force;
inserting the fastener (210) with the load distribution washer (200) into a working surface until the setting process is complete; and
returning the actuating element (140) vertically upward.

11. A method for setting a load distribution washer (200) with a fastener (210) using a setting device according to claim 1, comprising the following steps:
providing the setting device (100) with a load distribution washer supply (410) in the magazine (400) and a single one of the load distribution washers in a mounting position in the mounting bracket (300);
providing one of the fasteners (210) via the second feed device (120);
positioning the setting device (100) at a target position;
pressing down the actuating element (140), thereby translating a vertical movement of the pressure rod (145) into a downward movement of the drive mandrel (155) driven by the drive unit (150) along the working axis (900);
centering a fastener (210) in the mounting guide (320) on the working axis (900);
passing the fastener (210) guided and driven by the drive mandrel (155 through the through-opening (220);
due to a resulting lowering movement, engaging the the fastener (210) in the through-opening (220);
lifting the load distribution washer (200) off the contact surface (330) against the magnetic force;
inserting the fastener (210) with the load distribution washer (200) into a working surface until the setting process is complete, whereupon returning the actuating element (140) vertically upward effecting a horizontal movement of a feed blade (340);
moving a single said load distribution washer (200) from the magazine (400) in a channel (355) on a horizontal displacement path (350) into the mounting bracket (300) and holding said single load distribution washer (200) on the contact surface (330) by the magnet system (500), and
wherein the load distribution washer is held on the contact surface (330) without any further mechanical retainer about the working axis (900) such that the working axis (900) and the through-opening (220) of the load distribution washer (200) are aligned.
